(19) United States
(12) Patent Application Publication
(10) Pub. No.: US 2009/0177726 A1
(43) Pub. Date: Jul. 9, 2009

(54) METHOD FOR PROCESSING A DIGITAL INPUT SIGNAL IN A DIGITAL DOMAIN AND DIGITAL FILTER CIRCUIT FOR PROCESSING A DIGITAL INPUT SIGNAL

(75) Inventor: Andreas Bury, Dresden (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/305,736

(22) PCT Filed: May 16, 2007
(86) PCT No.: PCT/IB2007/051878

§ 371 Date: Dec. 19, 2008

(30) Foreign Application Priority Data
Jun. 20, 2006 (EP) 06115698.0

(51) Int. Cl. G06F 17/17

(52) U.S. Cl. 708/313; 381/94.4; 327/261

(57) ABSTRACT

The invention relates to a method for processing a digital input signal (x(i)) in a digital domain, comprising: -sampling a wideband of input frequencies of said digital input signal (x(i)) with a sampling frequency (fs), which decimates with a decimation factor (D), -linear shaping said sampled input frequencies with a configurable delay, -producing an output signal (y(i)) containing said linear shaped input frequencies, wherein the output signal (y(i)) has the same sampling frequency (fs) as said input signal (x(i)).

The present invention relates to a method for processing a digital input signal, for instance for application in a digital loudspeaker system. Furthermore, the invention relates to a digital filter circuit especially used in a digital loudspeaker system.

Digital filters have replaced traditional analogue filters in many applications. In particular, high-frequency digital filters are increasingly used in wireless networking equipment and other radio-frequency applications, such as in active loudspeaker system.

The digital sound quality of an active loudspeaker system provided by crossover networks and power amplifiers has substantially improved in recent years, driven by advances in MOSFET technology and integrated circuit design techniques. Active loudspeakers, e.g. multi-way loudspeaker system, comprising crossover networks are known from certain manufacturers, e.g. T+A. Passive crossover networks need bulky inductors and capacitors. In general crossover networks, either active or passive, will always introduce a group delay distortion in the overall response, corresponding to one bandpass per crossover. Especially, digital crossover networks employ a huge amount of processing time for digital filtering. Furthermore, the known digital filter which supports a direct implementation of a finite-impulse response (FIR) filter for high-Q shaping filtering at low frequencies exhibits a very long impulse response and therefore a typical very high implementation complexity.

Therefore, the object of the invention is to provide an improved method for processing digital input signal having improved rejection characteristics without greatly increasing the complexity of filter characteristics. Furthermore, the object of the invention is to provide a digital filter circuit with a low-complexity solution.

The above mentioned object is achieved by a method for processing a digital input signal x(i) in a digital domain comprising:
sampling a wideband of input frequencies of said digital input signal x(i) with a sampling frequency fs, which decimates with a decimation factor D,
linear shaping said sampled input frequencies with a configurable delay,
producing an output signal y(i) containing said linear shaped input frequencies, wherein the output signal y(i) has the same sampling frequency fs as said input signal x(i).

The key of the invention is the linear shaping of the digital input signal x(i). The invention provides a novel technique for a digital filter structure which permits to implement shaping filtering according to a desired amplitude and phase response, in such a way that a low implementation complexity is achieved even for high-Q shaping filtering functions at very low frequency, compared to the sampling frequency fs.

In a preferred embodiment of the invention, the sampling frequency fs is decimated by a predetermined decimation factor D in each stage N to a decimator output signal with the following frequencies fs/Dⁿ with n=0 to N. Preferably, the decimation factor D is two. When the predetermined decimation factor D is two, half of the band of input frequencies is applied for linear shaping. In other words: The proposed structure consists of a chain of successive linear phase halfband decimation filters, especially FIR filters, to split the input signal x(i) into octave-spaced bands (shortly called “analysis chain”) whereby the sampling frequency fs is divided by two from one stage N to the next stage N+1.

In a further embodiment of the invention, said decimator output signal is linear shaped into a shaping filter output signal by a digital shaping filter bank with different passbands and with a configurable delay. For linear shaping filtering of the decimator output signals a number of individual FIR filters are specifically designed in such a way, that the overall structure approximates a desired overall target response.

Afterwards, said shaping filter output signal is sampled up and interpolated by the same predetermined decimation factor D, e.g. with D=2, to said output signal y(i). In other words: The shaping filter output signals of the shaping filter bank are up-sampled by two using a chain of successive halfband interpolators, e.g. FIR interpolators, in such a way that signals of identical sampling frequency fs are summed before the next up-sampling (shortly called “synthesis chain”).

The preferred digital filter circuit comprises:
at least one analysis chain for sampling a wideband of input frequencies of the digital input signal x(i) with a sampling frequency fs, which decimates with a decimation factor D,
at least one digital shaping filter bank coupled to the outputs of said analysis chain for linear shaping said sampling input frequencies with a configurable delay,
at least one synthesis chain coupled to the outputs of said digital shaping filter bank for producing an output signal y(i) containing said linear shaped input frequencies, wherein the output signal y(i) has the same sampling frequency fs as the input signal x(i).

Said analysis chain comprises at least one decimator, which decimates said digital input signal x(i) by low pass filtering and subsequent down-sampling in compliance with the sampling theorem thus producing a decimator output signal. Additionally, said analysis chain comprises at least two decimators, wherein a decimator output signal of at least one of said decimators is the decimator input signal of another one of said decimators. For instance, the digital input signal x(i) is successively down-sampled by the decimation factor D with the value two using for instance a chain of FIR halfband decimators.

The decimator output signals of the analysis chain are fed to the shaping filter bank which comprises individual FIR shaping filters. Said shaping filter bank comprises at least two especially linear-phase finite-impulse response shaping filters (furthermore shortly called FIR shaping filter) each having a configurable nonzero impulse response of a certain length in series with the configurable delay and which one of said decimator output signals or a decimator input signal is fed to and which thereof generates a shaping filter output signal. Such designed individual FIR shaping filter allows a flexible filter implementation at a minimum complexity, i.e., minimum number of multiplications. Furthermore, to design the shaping filter bank, the overall target frequency response is first cleaned by filtering the transfer function with a Gauss impulse whose width is proportional to the frequency or whose width varies with frequency according to the so called Mel scale. Pulses alternative to the Gauss pulse may be used. After cleaning, the overall target frequency response is weighted by a set of overlapping, frequency dependent weighting functions, in order to obtain the target responses for the individual FIR shaping filters of the shaping filter bank. These individual FIR shaping filters are designed to use a least-square method in the frequency domain.

Furthermore, the synthesis chain comprises at least one adder and one interpolator to which the shaping filter output signal is fed, whereby said shaping filter output signal is sampled up and interpolated to produce an interpolator output signal and whereby said adder adds one of said shaping filter output signals and one of said interpolator output signals both having the same sampling frequency fs thus producing an adder output signal y(i). In particular, the synthesis chain comprises at least two of said interpolators and at least two of said adders, wherein said shaping filter output signal of at least one of said interpolators is the adder output signal of an adder. In a further embodiment, all interpolators interpolate by the same decimation factor D of all decimators, wherein the decimation factor D is two. In other words: Shaping filter output signals are fed to a chain of successive halfband interpolators, which perform up-sampling by factors of two in such a way, that signals of identical sampling frequency fs are summed before the next interpolation/up-sampling.

The described digital filter circuit may be used for designing a joint crossover and shaping network in an active loudspeaker system with a digital crossover network and an individual digital power amplifier for each loudspeaker. Furthermore, the invention may be used for a method to design wideband shaping filters using a target response for the overall filters, which may be derived from measurement data.

In an application of the shaping filter bank structured for a digital crossover network in a loudspeaker system, where the entire input frequency band shall be split among several loudspeakers, each with its respective band, only a single analysis chain may be used, thus reducing computational complexity. Furthermore, since each loudspeaker covers only a fraction of the input frequency band, a number of FIR shaping filters in the shaping filter bank shall be saved per loudspeaker, thus reducing complexity even more. In this way, the complexity of the digital crossover network for a loudspeaker system is dominated mainly by the FIR shaping filter for the highest frequency component, which may be present only for the tweeter, i.e., complexity does not grow significantly with the number of loudspeakers in the loudspeaker system.

The foregoing and other objectives, features and advantages of the invention will be apparent from the following, more particular, description of the embodiments of the invention with reference to the accompanying drawings, in which:

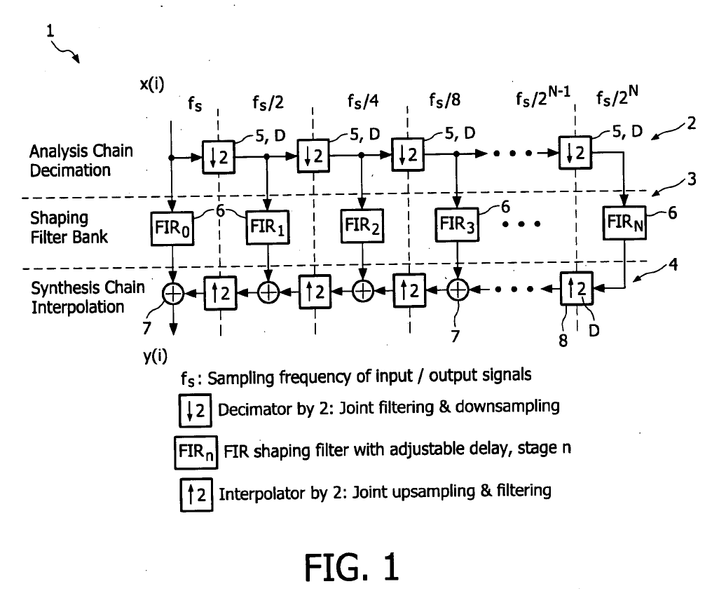

FIG. 1 shows a schematic of a digital filter circuit with an analysis chain, a shaping filter bank and a synthesis chain,

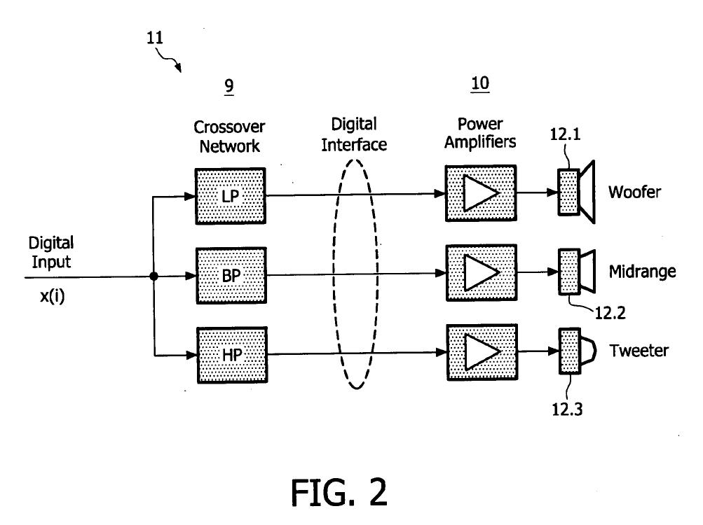

FIG. 2 shows a schematic of an application of the system for processing a digital input in a crossover network for a digital active loudspeaker system,

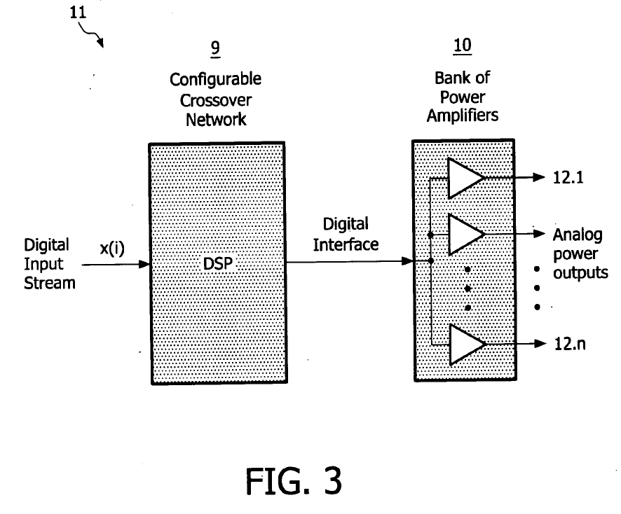

FIG. 3 shows a schematic of a customer application of said digital crossover network for a digital active loudspeaker system,

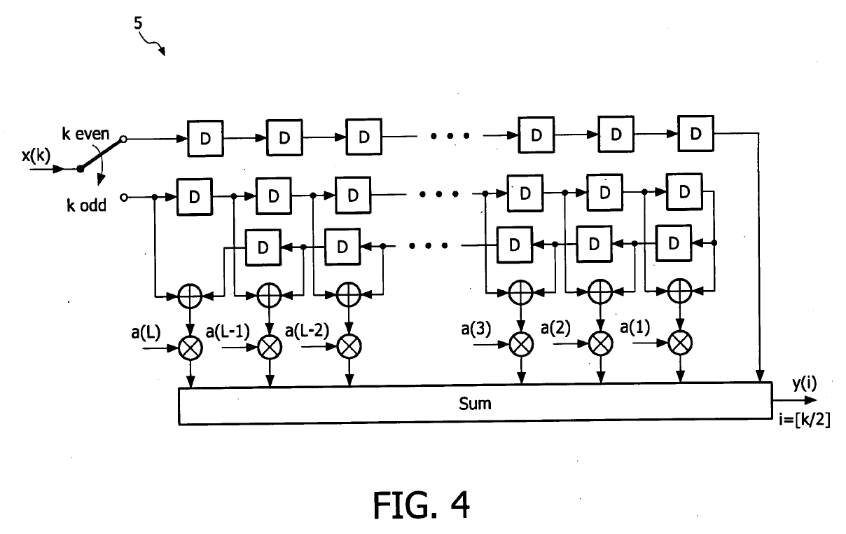

FIG. 4 shows a schematic of a halfband decimator,

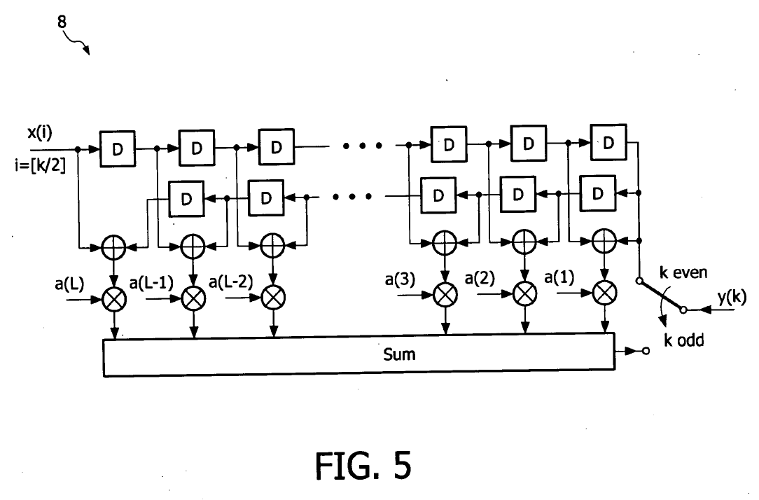

FIG. 5 shows a schematic of a halfband interpolator,

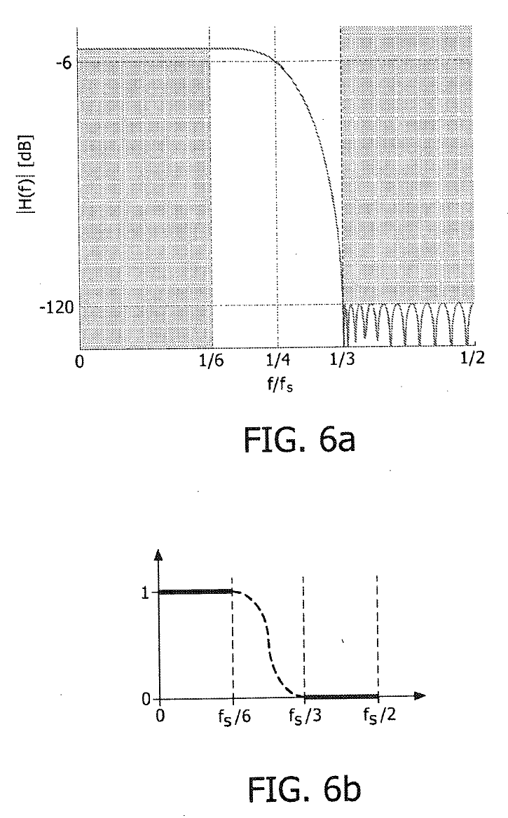

FIG. 6a, 6b show diagrams with possible transition regions of the halfband decimator or interpolator,

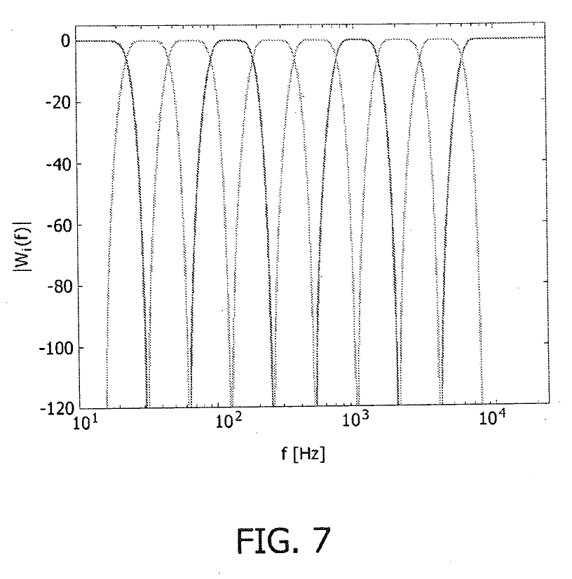

FIG. 7 shows a diagram of the weighting function of sub-bands of the input signal,

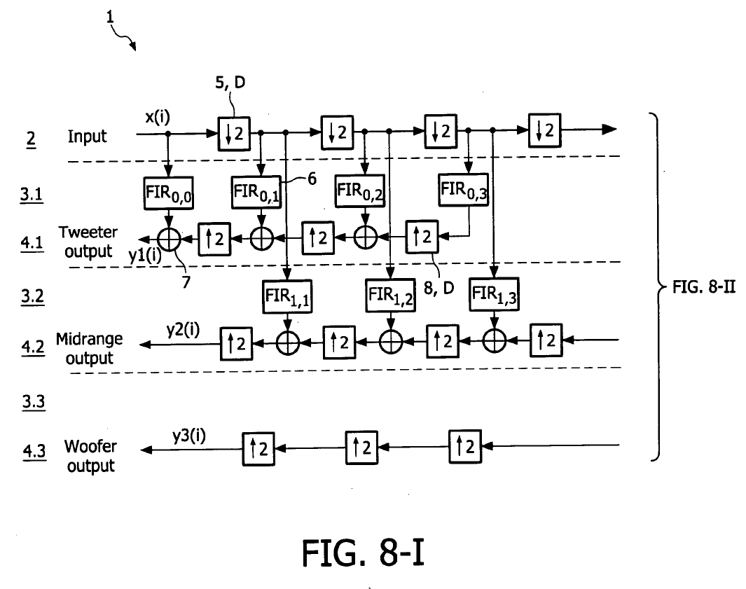

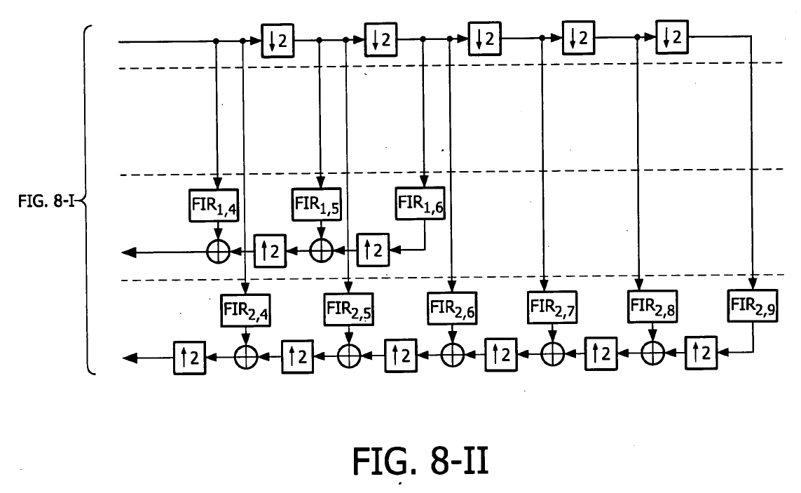

FIG. 8 shows a block diagram of a digital crossover network in a 3-way loudspeaker system, and

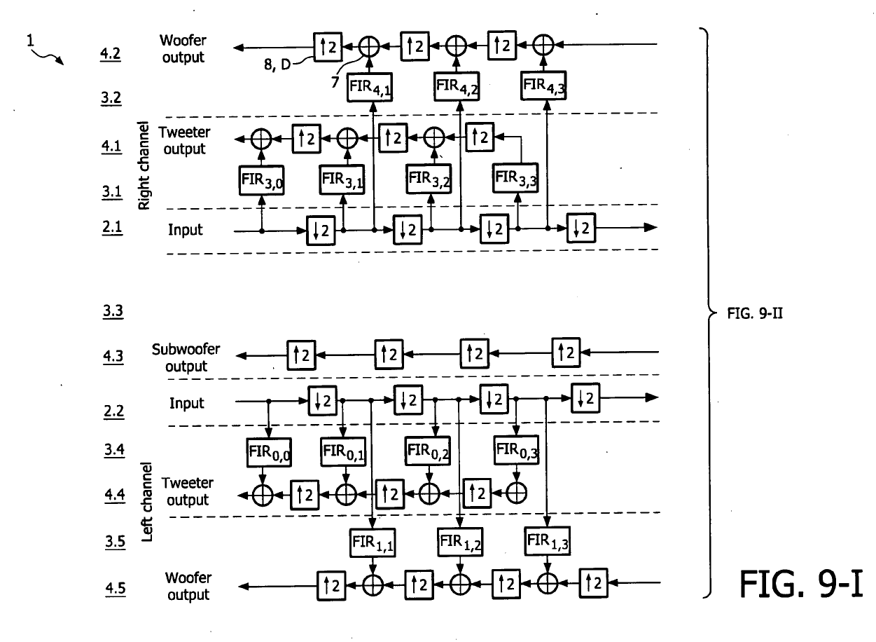

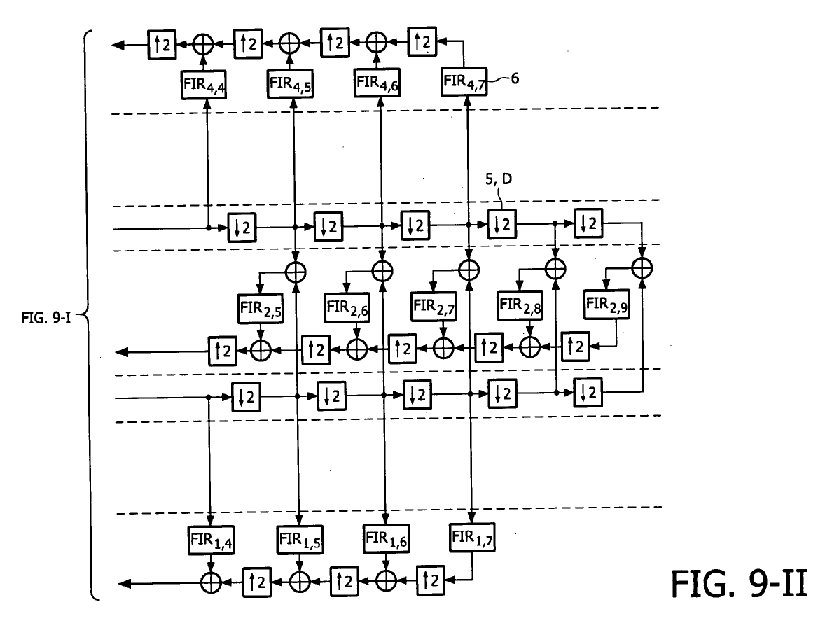

FIG. 9 shows a block diagram of a digital crossover network for a subwoofer/satellite loudspeaker system.

FIG. 1 shows a schematic of a digital filter circuit 1 with an analysis chain 2, a shaping filter bank 3 and a synthesis chain 4.

In the analysis chain 2, an input signal x(i) at sampling frequency fs is successively decimated by a decimation factor D of two, where the decimation consists of a decimation filtering, e.g. a low pass filtering, and subsequent down-sampling in compliance with the sampling theorem. In the described embodiment, the analysis chain 2 comprises a predetermined number of decimators 5, wherein a decimator output signal of at least one of said decimators is the decimator input signal of another one of said decimators 5.

The predetermined number of decimators 5 depends on the given application, e.g., for a 3-way loudspeaker system, and equals a relevant application-dependent number of stages N. In more detail, the sampling frequency fs is decimated by the predetermined decimation factor D, especially with D=2,in each stage N into the decimator output signal with the following frequencies fs/Dⁿ with n=0 to N (with fs=sampling frequency, D=decimation factor, N=number of stage).

Such decimated input frequencies fs/2ⁿ are fed to respective individual FIR shaping filters 6 of the shaping filter bank 3. The number of individual FIR shaping filter 6 equals the number of stage N. The individual FIR shaping filters 6 are specifically designed in such a way, that the overall structure approximates a desired overall target response. Each FIR shaping filter 6 have a configurable nonzero impulse response of a certain length in series with a configurable delay, in order to support flexible filter implementation at a minimum complexity.

In a further embodiment of the invention, one or more of the FIR shaping filter 6, e.g. FIR shaping filter 6 for the highest frequency, are FFT-based (FFT=fast fourier transformation) rather than direct implementation of entire shaping. This will reduce complexity further particularly for FIR shaping filters 6 operating at the highest frequency. In other words: For each stage N an individual FIR shaping filter 6 is implemented, wherein the FIR shaping filters 6 for lowest frequency are directly implemented and the FIR shaping filters 6 for highest frequency are FFT-based.

Afterwards, in the synthesis chain 4 shaping filter output signals of the shaping filter bank 3 are successively interpolated by the same decimation factor D of two, where the interpolation consists of up-sampling and subsequent interpolation filtering, such that signals at identical sampling frequency fs are summed before the respective next interpolation stage. In detail, the synthesis chain 4 comprises at least one adder 7 to which the shaping filter output signal is fed and one interpolator 8, whereby said shaping filter output signal is sampled up and interpolated to produce an interpolator output signal and whereby said adder 7 adds one of said shaping filter output signals and one of said interpolator output signals both having the same sampling frequency fs thus producing an adder output signal y(i).

In the shown embodiment, the synthesis chain 4 comprises a number of adders 7 and interpolators 8, wherein the interpolator input signal of at least one of said interpolators 8 is the adder output signal of an adder 7.

In FIG. 2 is shown a schematic of an application for the digital filter circuit 1 in a crossover network 9 with digital power amplifiers 10 for a digital active loudspeaker system 11. The digital input signal x(i) is splitted among several loudspeakers 12.1 to 12.3, each with its respective bandpass LP, BP and HP by the crossover network 9.

The digital filter circuit I may be implemented in an application-specific integrated circuit or in other suitable integrated circuit technology. The digital filter 1 may also be implemented by program instructions performing steps in accordance with the method of the present invention for execution within a digital signal processor 13 (shortly called DSP) as shown in FIG. 3 or within a general-purpose microprocessor. In such an application transfer functions of all loudspeakers 12.1 to 12.3 are measured. The structure of the digital filter circuit I may be configured by defining bandpass characteristic of the overall system, selecting crossover frequencies and shapes, performing shaping filter design jointly for all loudspeakers 12.1 to 12.3 and defining an overall processing delay using the measured data, which may be cleaned e.g. by Gauss filtering.

FIG. 4 shows a possible embodiment of a halfband decimator 5. This embodiment uses halfband FIR decimators 5 to minimize the decimation complexity. These halfband FIR decimators 5 are based on halfband FIR lowpass filters, which have the following parameters for a length M with filter function h(m) with M in {3, 7, 11, 15, 19 . . . }, 0<=m<=M−1:
h(m)=h(M−1−m)
h(m)=0 for even M and m not equal to (M−1)/2.

For a filter length L, only (L+1)/4 multiplications are required.

In FIG. 5 is similarly shown the halfband interpolator 8, implemented as a halfband FIR interpolator based on halfband FIR lowpass filters.

FIGS. 6a and 6b show diagrams with possible transition regions of the halfband decimator 5 or interpolator 8. The bandpass ranges from zero to one sixth of the sampling frequency fs, and the bandstopp ranges from one third of the sampling frequency fs up to the Nyquist frequency. In other words: The transition region is one third of the available bandwidth.

In a further embodiment of the invention, the individual FIR shaping filters 6 are designed by weighting of an overall target response by sub-band specific weighting functions. The weighting functions are defined in such a way that they sum up to a constant across the range of the input or entire frequency x(i) between the first and the last weighting function; shown in FIG. 7 (diagram of the weighting function of sub-bands of the input signal x(i)).

Alternatively, FIR shaping filters 6 may be designed according to sub-band specific target response using least-square method in the frequency domain.

In a further alternative embodiment, the individual FIR shaping filters 6 may be designed according to an overall target response which is the filtered (=cleaned) version of an original target response, where the filtering consists in Gauss filtering of the transfer function in the frequency domain using a Gauss signal whose width is proportional to frequency or following a so called Mel-scale. Another function than the Gauss signal may be used.

Another embodiment extends the shaping filter bank 3 to multiple output signals in such a way that only one single analysis chain 2 is implemented, which feeds down-sampled input frequencies to multiple shaping filter banks 3.1 to 3.3 and synthesis chains 4.1 to 4.3, as shown in FIG. 8. The FIG. 8 shows a block diagram of a digital crossover network 9 in a 3-way loudspeaker system 11. The sharing of the single analysis chain 2 to the multiple shaping filter banks 3.1 to 3.3 minimizes the complexity. In this embodiment, the respective multiple shaping filter banks 3.1 to 3.3 and the multiple synthesis chains 4.1 to 4.3 for multiple output signals y1(i) (=tweeter output), y2(i) (=midrange output) and y3(i) (=woofer output) are implemented only partially, in order to further minimize complexity in applications where the respective outputs y1(i) to y3(i) deliver only part of the input frequency band. Preferable, in this application the number of bands or sub-bands may be changed for each loudspeaker 12.1 to 12.3 by changing the number of stage N for the respective loudspeakers 12.1 to 12.3.

In an alternative embodiment, the crossover network 9 uses a joint design of multiple shaping filter banks 3.1 to 3.3, such that the overall response of the system including the digital crossover network 9. The multiple loudspeakers 12.1 to 12.3 satisfy a certain target response in the conversion from digital input signal x(i) to acoustic waves.

The FIG. 9 shows a block diagram of an alternative embodiment of a digital crossover network 9, e.g. for a subwoofer/ satellite loudspeaker system 11 with five loudspeakers 12.1 to 12.5, one subwoofer and two satellites. This embodiment uses multiple input signals x1(i), x2(i) and multiple analysis chain 2.1, 2.2 and combines the decimated analysis chain outputs before feeding them into some out of a set of shaping filter banks 3.1 to 3.5 and associated synthesis chains 4.1 to 4.5. For the subwoofer path, the two analysis chains 2.1 and 2.2 (also called decimated left channel and decimated right channel) are combined before shaping filtering.

The described key concept of the invention allows one application for different active digital loudspeakers for Hi-Fi and Multi-Media with digital interface, including a digital crossover network, digital power amplifier for all loudspeakers and a power management unit. Another application is sound reproduction systems, like in mobile phones, in cars or for TV sets.

1. Method for processing a digital input signal in a digital domain, comprising:
sampling a wideband of input frequencies of said digital input signal with a sampling frequency, which decimates with a decimation factor,
linear shaping said sampled input frequencies with a configurable delay,
producing an output signal containing said linear shaped input frequencies, wherein the output signal has the same sampling frequency as said input signal.

2. Method according to claim 1, characterized in that the sampling frequency is decimated by a predetermined decimation factor in each stage to a decimator output signal with the following frequencies fs/Dⁿ with n=0 to N.

3. Method according to claim 2, characterized in that when the predetermined decimation factor is two, half of the band of input frequencies is applied for linear shaping.

4. Method according to claim 2, characterized in that said decimator output signal is linear shaped to a shaping filter output signal by a digital shaping filter bank with different bandpass and with an configurable delay.

5. Method according to claim 4, characterized in that said shaping filter output signal is sampled up and interpolated by the same predetermined decimation factor to said output signal.

6. Digital filter circuit, comprising:
at least one analysis chain for sampling a wideband of input frequencies of said digital input signal with a sampling frequency, which decimates with a decimation factor,
at least one digital shaping filter bank coupled to the outputs of said analysis chain for linear shaping said sampling input frequencies with a configurable delay,
at least one synthesis chain coupled to the outputs of said digital shaping filter bank for generating an output signal containing said linear shaped input frequencies, wherein the output signal has the same sampling frequency as the input signal.

7. Digital filter circuit according to claim 6, wherein said analysis chain comprises at least one decimator, which decimates said digital input signal by low pass filtering and subsequent down-sampling in compliance with the sampling theorem thus producing a decimator output signal.

8. Digital filter circuit according to claim 7, characterized in that said shaping filter bank comprises at least two linear-phase finite-impulse response shaping filters each having a configurable nonzero impulse response of a certain length in series with a configurable delay and which one of said decimator output signals or a decimator input signal is fed to and which thereof generates a shaping filter output signal.

9. Digital filter circuit according to claim 8, characterized in that said synthesis chain comprises at least one adder and one interpolator to which the shaping filter output signal is fed, whereby said shaping filter output signal is sampled up and interpolated to produce an interpolator output signal and whereby said adder adds one of said shaping filter output signals and one of said interpolator output signals both having the same sampling frequency thus producing an adder output signal.

10. Digital filter circuit according to claim 6, wherein said analysis chain comprises at least two decimators, wherein a decimator output signal of at least one of said decimators is the decimator input signal of another one of said decimators.

11. Digital filter circuit according to claim 9, wherein said synthesis chain comprises at least two of said interpolators and at least two of said adders, wherein said shaping filter output signal of at least one of said interpolators is the adder output signal of an adder.

12. Digital filter circuit accordingly to claim 6, wherein all decimators decimate by the same decimation factor and that all interpolators interpolate by said decimation factor.

13. Digital filter circuit according to claim 12, wherein the decimation factor is two.

14. (canceled)
